(19) United States
(12) Patent Application Publication
(10) Pub. No.: US 2024/0208330 A1
(43) Pub. Date: Jun. 27, 2024

(54) IN-VEHICLE DISPLAY APPARATUS AND AUTOMOBILE

(71) Applicant: ROHM CO., LTD., Kyoto-shi (JP)

(72) Inventors: Hirotoshi USUI, Kyoto-shi (JP); Tomohiko SUMI, Kyoto-shi (JP)

(21) Appl. No.: 18/594,224

(22) Filed: Mar. 4, 2024

Related U.S. Application Data
(63) Continuation of application No. PCT/JP2022/032934, filed on Sep. 1, 2022.

(30) Foreign Application Priority Data
Sep. 6, 2021 (JP) 2021-145002

(51) Int. Cl. B60K 35/22; G02F 1/1335; G02F 1/13357

(52) U.S. Cl. CPC B60K 35/22; G02F 1/133524; G02F 1/133615; B60K 2360/1523; B60K 2360/332

(57) ABSTRACT

An in-vehicle display apparatus includes a liquid crystal display panel and a backlight apparatus. An edge-type backlight apparatus is provided on the back surface of the liquid crystal display panel. In the liquid crystal display panel, each of the plurality of areas emits light with predefined relative luminance.

### CROSS REFERENCE TO PRIOR APPLICATIONS

This application is a continuation under 35 U.S.C. § 120 of PCT/JP2022/032934, filed Sep. 1, 2022, which is incorporated herein by reference, and which claimed priority to Japanese Application No. 2021-145002, Sep. 6, 2021. The present application likewise claims priority under 35 U.S.C. § 119 to Japanese Application No. 2021-145002, Sep. 6, 2021, the entire content of which is also incorporated herein by reference.

### BACKGROUND

### 1. Technical Field

The present disclosure relates to an in-vehicle display.

### 2. Description of the Related Art

In some recent automobiles, replacement from a conventional analog cluster meter to a liquid crystal display panel has been promoted.

Since automobiles travel outdoors, the visibility of the liquid crystal display panels may be reduced due to the influence of sunlight.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a diagram illustrating an automobile including an in-vehicle display apparatus according to an embodiment;

FIG. 2 is a block diagram of the in-vehicle display apparatus according to an embodiment;

FIG. 3 is a view for explaining an operation of the in-vehicle display apparatus in FIG. 2;

FIG. 4 is a view illustrating a configuration example of a light guide of a backlight apparatus; and

FIG. 5 is a view for explaining an operation of the in-vehicle display apparatus according to a second modification.

### DETAILED DESCRIPTION

### Summary of Embodiment

A summary of some example embodiments of the present disclosure will be described. This summary describes some concepts of one or more embodiments in a simplified manner for the purpose of basic understanding of the embodiments as a prelude to the detailed description that follows and does not limit the breadth of the invention or disclosure. This summary is not a comprehensive summary of all possible embodiments and is not intended to identify key elements of all embodiments or delineate the scope of some or all aspects. For convenience, “one embodiment” may be used to refer to one embodiment (example or modification) or a plurality of embodiments (examples or modifications) disclosed in the present specification.

An in-vehicle display apparatus according to one embodiment includes a liquid crystal display panel, an edge-type backlight apparatus provided on a back surface of the liquid crystal display panel and structured to have each of a plurality of areas emit light with a predefined relative luminance.

In the in-vehicle display apparatus, images indicating a plurality of instruments or meters, images of maps, and images related to other information are arranged in a predetermined layout in a horizontal direction. Therefore, the black region in which meaningful information is not displayed is always present fixedly at the same position in the horizontal direction. Therefore, the visibility can be improved by setting the luminance of the area corresponding to such a black region relatively low. This technique should not be equated with local dimming employed in general displays for televisions and PCs. That is, while the local dimming is intended to increase a dynamic range using a direct-type backlight, the dimming of the area in one embodiment is intended not to expand the dynamic range but to achieve visibility. In addition, the local dimming in a general television or the like requires real-time analysis of image data to be displayed from moment to moment, whereas dimming of a plurality of areas in one embodiment does not require real-time analysis of image data, and thus hardware can be significantly simplified.

In one embodiment, the layout of the information displayed on the liquid crystal display panel may be changeable. The relative luminance of the plurality of areas may be defined for each layout. As a result, when the layout is changed and the black region moves, the backlight of the portion can be darkened following the movement.

In one embodiment, the backlight apparatus includes a plurality of semiconductor light sources arranged along one longitudinal side of the liquid crystal display panel, a light guide plate arranged on a back side of the liquid crystal display panel, and a drive circuit that drives the plurality of semiconductor light sources to emit light with predefined relative luminance.

In one embodiment, the light guide plate may include a plurality of light guides arranged in a horizontal direction. By dividing the light guide plate into a plurality of parts in the horizontal direction, it is possible to prevent blurr on display.

In one embodiment, a gap may be inserted between adjacent light guides. In one embodiment, a partition wall (partition plate) may be inserted between adjacent light guides. This can further prevent light blur on display.

### Embodiment

Hereinafter, a preferred embodiment will be described with reference to the drawings. The same or equivalent components, members, and processes illustrated in the drawings are denoted by the same reference numerals, and redundant description will be omitted as appropriate. Further, the embodiments are not intended to limit the disclosure and the invention, but are merely examples, and all features described in the embodiments and combinations thereof are not necessarily essential to the disclosure and the invention.

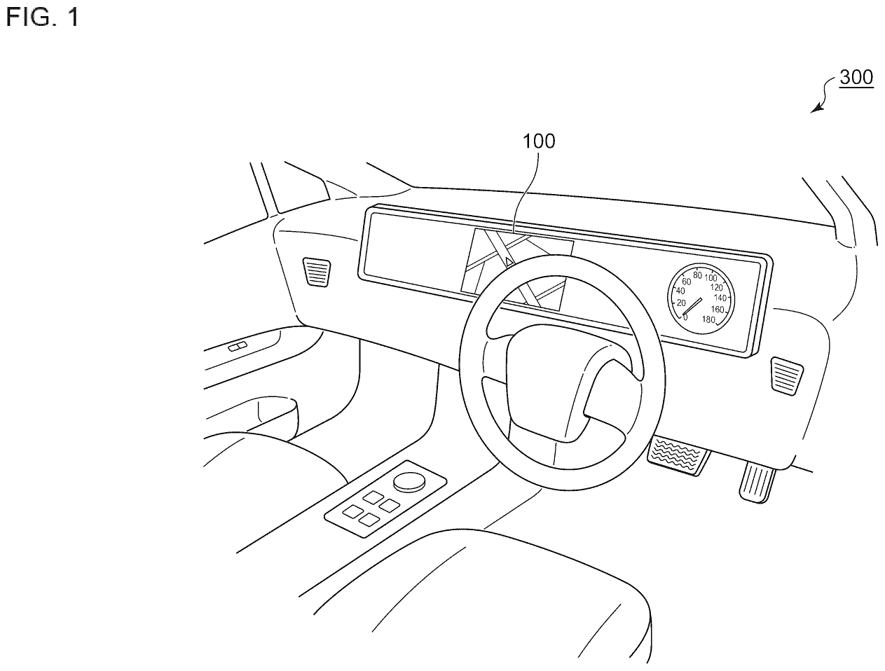

FIG. 1 is a diagram illustrating an automobile 300 including an in-vehicle display apparatus 100 according to an embodiment. The in-vehicle display apparatus 100 is arranged in front of a driver's seat of an automobile, and displays a speedometer, a tachometer, a fuel meter, various warning lights, and the like as image information. The in-vehicle display apparatus 100 can also display car navigation information, an image related to entertainment, and the like.

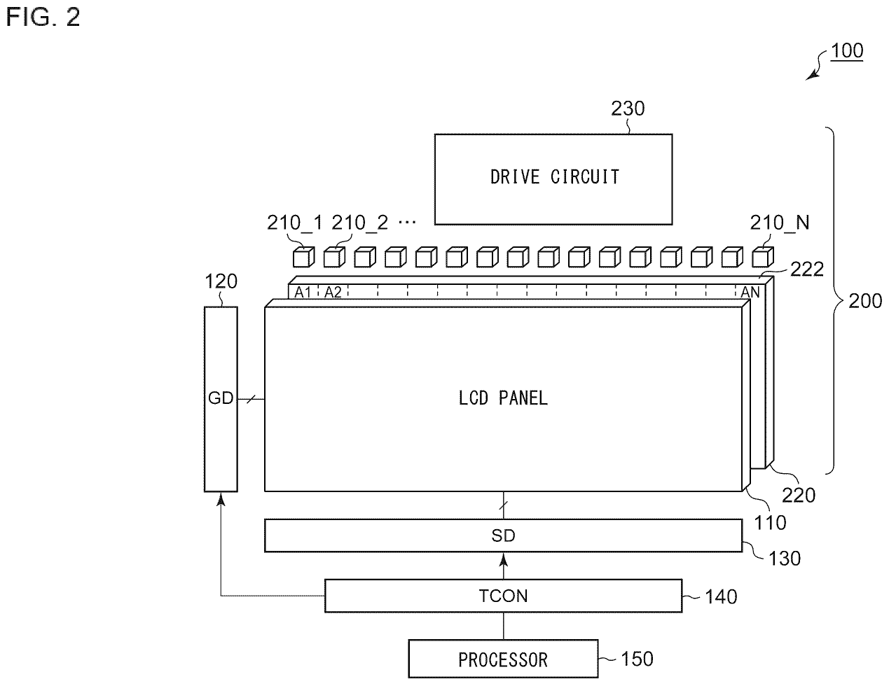

FIG. 2 is a block diagram of the in-vehicle display apparatus 100 according to an embodiment. The in-vehicle display apparatus 100 includes a liquid crystal display panel 110, a gate driver 120, a source driver 130, a timing controller 140, a processor 150, and a backlight apparatus 200.

The liquid crystal display panel 110 has a rectangular shape with a first direction (in this example, a horizontal direction) as a longitudinal direction and a second direction (in this example, a vertical direction) as a lateral direction. The processor 150 is typically a graphics processing unit (GPU), a graphics engine, an image display electronic control unit (ECU), or the like, and generates image data to be displayed on the liquid crystal display panel 110. The timing controller 140 receives the image data and transmits various timing signals and RGB data to the gate driver 120 and the source driver 130.

The backlight apparatus 200 is provided on the back surface of the liquid crystal display panel 110. The backlight apparatus 200 is of an edge type and is divided into a plurality of N (N is an integer) areas A₁ to A_{N} in the longitudinal direction of the liquid crystal display panel 110. In the backlight apparatus 200, the plurality of areas A₁ to A_{N} emit light with predefined relative luminance.

The backlight apparatus 200 includes N semiconductor light sources 210_1 to 210_N, a light guide 220, and a drive circuit 230. The N semiconductor light sources 210_1 to 210_N correspond to areas A₁ to A_{N} that are units of dimming and are arranged along one longitudinal side (upper side in this example) of the liquid crystal display panel 110. The semiconductor light source 210 is, for example, a light emitting diode (LED), a laser diode (LD), an organic electro luminescence (EL) element, or the like, but is assumed to be an LED in the present embodiment.

The light guide 220 is disposed on the back side of the liquid crystal display panel 110. Light emitted from semiconductor light sources 210_1 to 210_N is coupled to an incident end 222 of the light guide 220. The coupled light is guided in the light guide 220 in the vertical direction.

The drive circuit 230 is an LED driver and drives the plurality of semiconductor light sources 210_1 to 210_N to emit light with a predefined relative luminance. The luminance of the plurality of semiconductor light sources 210_1 to 210_N correspond to the luminance of the plurality of areas A₁ to A_{N}.

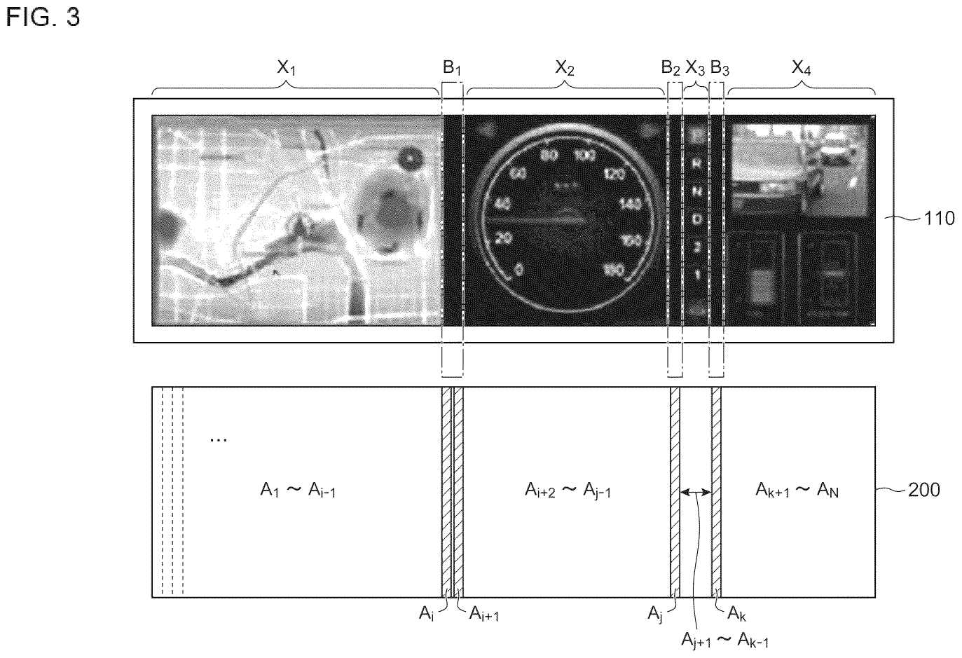

The above is the configuration of the in-vehicle display apparatus 100. Next, the operation will be described. FIG. 3 is a view for explaining an operation of the in-vehicle display apparatus 100 in FIG. 2. An example of a screen of the liquid crystal display panel 110 is illustrated in the upper part of FIG. 3, and the backlight apparatus 200 is illustrated in the lower part.

In the screen, a portion where all pixels, 90% or more, or 80% or more pixels are black in the vertical direction is referred to as a black region. In the example of FIG. 3, there are three black regions B₁ to B₃. The black region B may occur between a region displaying one piece of information and a region displaying another piece of information. For example, the black region B₁ exists between a region X₁ where map information is displayed and region X₂ where the speedometer is displayed. The black region B₂ exists between the region X₂ where the speedometer is displayed and the region X₃ where the gear is displayed. The black region B₃ exists between the region X₃ where the gear is displayed and a region X₄ where a camera image or the like is displayed.

Among the plurality of areas A₁ to A_{N} of the backlight apparatus 200, the luminance of the area in which all or most of the area overlaps with the black region B is determined to be relatively lower than the luminance of the other areas. In the example of FIG. 3, the i-th and (i+1)-th areas Aᵢ and Aᵢ+1 from the left overlap the black region B₁, the j-th area Aⱼ overlaps the black region B₂, and the k-th area Aₖ overlaps the black region B₃. Therefore, the luminance of the areas Aᵢ, Aᵢ+1, Aⱼ, and Aₖ is relatively lower than the luminance of the remaining areas A₁ to Aᵢ₋₁, Aᵢ₊₂ to Aⱼ₋₁, Aⱼ₊₁ to Aₖ₋₁, and Aₖ₊₁ to A_{N}. For example, the luminance of the areas (also referred to as low luminance areas) Aᵢ, Aᵢ₊₁, Aⱼ, and Aₖ overlapping the black region may be 0, or may be a constant α times the luminance of the remaining areas (α<1).

The above is the operation of the in-vehicle display apparatus 100. Advantages of the in-vehicle display apparatus 100 will be described.

In the in-vehicle display apparatus 100, images indicating a plurality of instruments or meters, images of maps, and images related to other information are arranged in a predetermined layout in a horizontal direction. Each of these images changes from moment to moment, but a black region in which meaningful information is not displayed is always present fixedly at the same position between the images.

Therefore, by setting the luminance of the area corresponding to such a black region relatively low, the black portion of the screen becomes dark, and visibility in a situation where the surroundings are bright can be improved.

In the local dimming for expanding the dynamic range adopted for a normal television, it is necessary to change brightness of a backlight for each local area in a screen, and thus the direct-type backlight is adopted. On the other hand, in the dimming for improving the visibility in the in-vehicle display apparatus 100, the black region occurs in a band shape in the vertical direction. Therefore, the edge-type backlight can be adopted instead of the direct-type backlight. Since the cost of the edge-type backlight is lower than the cost of the direct-type backlight, it can be said that the hurdle for introduction of the in-vehicle display apparatus 100 is low.

In addition, in the local dimming for expanding the dynamic range, since a dark portion and a bright portion in a screen change from moment to moment, it is necessary to analyze an image in real time and control brightness for each area. On the other hand, in the dimming for improving the visibility in the in-vehicle display apparatus 100, the positions of the black region and the low luminance area corresponding thereto do not change with the lapse of time. Therefore, the positions of the low luminance areas can be known in advance at the design stage, and accordingly, the luminance of the semiconductor light source 210 corresponding thereto can also be determined in advance. That is, real-time image processing is unnecessary.

Next, a modification of the in-vehicle display apparatus 100 will be described.

### First Modification

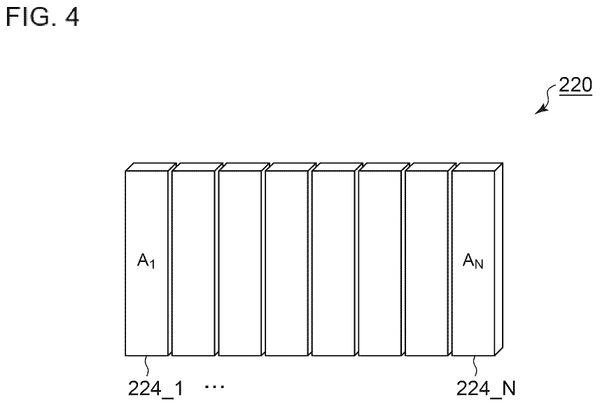

FIG. 4 is a view illustrating a configuration example of the light guide 220 of the backlight apparatus 200. The light guide 220 is divided into N light guides 224 corresponding to the N areas A₁ to A_{N}. A gap is inserted between the adjacent light guides 224. A partition wall (partition plate) may be inserted between the adjacent light guides 224 instead of the gap. As a result, it is possible to prevent light from leaking from a certain light guide to a light guide adjacent thereto, and a blur can be reduced.

### Second Modification

As described above, the image displayed on the liquid crystal display panel 110 includes a plurality of pieces of information. The layout of the information displayed on the liquid crystal display panel may be changeable for each vehicle type or in a certain vehicle type according to the user setting. In this case, the relative luminance of the plurality of areas A₁ to A_{N} is defined for each layout. The drive circuit 230 selects the relative luminance corresponding to the current layout, and drives the plurality of semiconductor light sources 210_1 to 210_N.

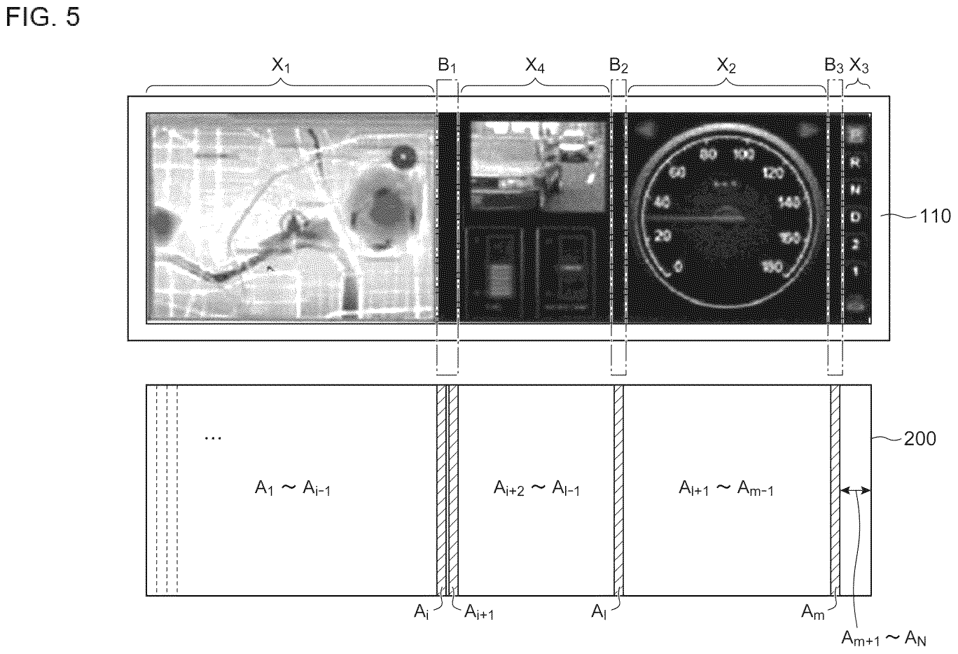

FIG. 5 is a view for explaining an operation of the in-vehicle display apparatus 100 according to the second modification. An example of a screen of the liquid crystal display panel 110 is illustrated in the upper part of FIG. 5, and the backlight apparatus 200 is illustrated in the lower part. In the liquid crystal display panel 110, the same information as that in FIG. 3 is illustrated, but the layout of the regions X₁ to X₄ is different from that in FIG. 3. The black region B₁ exists in the region X₁ where the map information is displayed and the region X₄ where a camera image or the like is displayed. The black region B₂ exists between the region X₄ where the camera image or the like is displayed and the region X₂ where the speedometer is displayed. The black region B₃ exists between the region X₂ where the speedometer is displayed and the region X₃ where the gear is displayed.

Thus, when the layout is changed, the positions of the black regions B₁ to B₃ change. According to the second modification, the relative luminance of the plurality of areas A₁ to A_{N} is defined for each layout, and when the black region moves by changing the layout, the backlight of the portion can be darkened following the movement.

### Third Modification

In the embodiment, the liquid crystal display panel 110 has been described as one panel, but the liquid crystal display panel 110 may be configured by connecting a plurality of panels in the horizontal direction.

### Fourth Modification

In FIG. 2, the single edge type backlight in which the plurality of semiconductor light sources 210 are arranged along the upper side of the light guide 220 has been described, but the plurality of semiconductor light sources 210 may be arranged along the lower side of the light guide 220. Alternatively, the plurality of semiconductor light sources 210 may be arranged along both the upper side and the lower side of light guide 220.

### Supplementary Note

The following techniques are disclosed herein.

### Item 1

An in-vehicle display apparatus including:
a liquid crystal display panel; and
an edge type backlight apparatus provided on a back surface of the liquid crystal display panel and structured to have each of a plurality of areas emit light with a predefined relative luminance.

### Item 2

The in-vehicle display apparatus according to Item 1, in which a layout of information to be displayed on the liquid crystal display panel is changeable, and
relative luminance of the plurality of areas is defined for each of the layouts.

### Item 3

The in-vehicle display apparatus according to Item 1 or 2, in which
the backlight apparatus includes:
a plurality of semiconductor light sources arranged along one longitudinal side of the liquid crystal display panel;
a light guide plate arranged on a back side of the liquid crystal display panel; and
a drive circuit structured to drive the plurality of semiconductor light sources to emit light with predefined relative luminance.

### Item 4

The in-vehicle display apparatus according to Item 3, in which the light guide plate includes a plurality of light guides arranged in a horizontal direction.

### Item 5

The in-vehicle display apparatus according to Item 4, in which a gap is inserted between adjacent light guides.

### Item 6

The in-vehicle display apparatus according to Item 4, in which a partition wall is inserted between adjacent light guides.

### Item 7

An automobile including the in-vehicle display apparatus according to any one of Items 1 to 6.

What is claimed is:

1. An in-vehicle display apparatus comprising:
a liquid crystal display panel; and
an edge type backlight apparatus provided on a back surface of the liquid crystal display panel and structured to have each of a plurality of areas emit light with a predefined relative luminance.

2. The in-vehicle display apparatus according to claim 1, wherein a layout of information to be displayed on the liquid crystal display panel is changeable, and
relative luminance of the plurality of areas is defined for each of the layouts.

3. The in-vehicle display apparatus according to claim 1, wherein
the backlight apparatus includes:
a plurality of semiconductor light sources arranged along one longitudinal side of the liquid crystal display panel;
a light guide plate arranged on a back side of the liquid crystal display panel; and
a drive circuit structured to drive the plurality of semiconductor light sources to emit light with predefined relative luminance.

4. The in-vehicle display apparatus according to claim 3, wherein the light guide plate includes a plurality of light guides arranged in a horizontal direction.

5. The in-vehicle display apparatus according to claim 4, wherein a gap is inserted between adjacent light guides.

6. The in-vehicle display apparatus according to claim 4, wherein a partition wall is inserted between adjacent light guides.

7. An automobile comprising the in-vehicle display apparatus according to claim 1.
